(19) United States
(12) Patent Application Publication
(10) Pub. No.: US 2016/0211686 A1
(43) Pub. Date: Jul. 21, 2016

(54) Device Storage Case and Charger

(71) Applicant: Michael Kovaly, Covington, WA (US)

(72) Inventor: Michael Kovaly, Covington, WA (US)

(21) Appl. No.: 14/598,760

(22) Filed: Jan. 16, 2015

(51) Int. Cl. H02J 7/00

(52) U.S. Cl. CPC H02J 7/0042

(57) ABSTRACT

An enclosed Device Storage Case and Charger may comprise a bottom portion with storage compartments configured to contain a plurality of devices, for example, point-of-view (POV) cameras and accessories. A top portion may serve as a lid while providing storage for items such as documents, electronic tablets or laptop computers, and accessories, for example. In one embodiment, the top portion may a power source such as photovoltaic (PV) solar panels. Device Storage Case and Charger may have multiple charging inputs via an extendable coil mounted inside the case, which may attach to a built-in surge protected device.

### FIELD

This disclosure relates generally to a Device Storage Case and Charger.

### BACKGROUND

Devices such as computers and cameras have become an integral part of people's lives. As devices become more mobile and compact, people often need them close at hand, especially during travel. Devices are susceptible to damage from pressure, excessive heat or cold, and moisture, for example. Traditional storage cases may not securely protect, carry and store multiple devices, such as point-of-view (POV) cameras and laptop computers, while allowing for multiple charging methods, such as solar charging.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

The instant application discloses, among other things, a Device Storage Case and Charger, which may comprise a bottom portion with compartments configured to contain multiple devices and accessories. For example, it may provide secure storage for multiple point-of-view (POV) cameras, such as GoPro® video cameras, and accessories. It may also include a top portion which may serve as a lid which also provides storage for documents, devices such as electronic tablets or laptop computers, and accessories, for example. In one embodiment, the top portion may include a photovoltaic (PV) solar power source or any other power source. Device Storage Case and Charger may include attachment means such as locking latches, corner eyelets, flush-mounted hinges, and fastening straps, for example, to keep contents secure. It may also include protective designs and materials, such as foam inserts and a water-tight enclosure, to prevent contents from sustaining damage.

Device Storage Case and Charger may have multiple charging inputs via an extendable coil mounted inside the case. It may have a built-in UL listed surge protected device. Standard AC adapters and USB cables may also be included.

Many of the attendant features may be more readily appreciated as they become better understood by reference to the following detailed description considered in connection with the attached drawings.

### BRIEF DESCRIPTION OF THE DRAWINGS

FIG. 1 illustrates a perspective view of a Device Storage Case and Charger, according to one embodiment.

FIG. 2 illustrates a perspective view of a bottom portion of a Device Storage Case and Charger, according to one embodiment.

FIG. 3 illustrates a bottom view of a Device Storage Case and Charger, according to one embodiment.

FIG. 4 illustrates a side view of a bottom portion of a Device Storage Case and Charger, according to one embodiment.

FIG. 5 illustrates a perspective view of a top portion of a Device Storage Case and Charger, according to one embodiment.

FIG. 6 illustrates a top view of a Device Storage Case and Charger, according to one embodiment.

FIG. 7 illustrates a side view of a top portion of a Device Storage Case and Charger, according to one embodiment.

Like reference numerals are used to designate like parts in the accompanying drawings.

### DETAILED DESCRIPTION

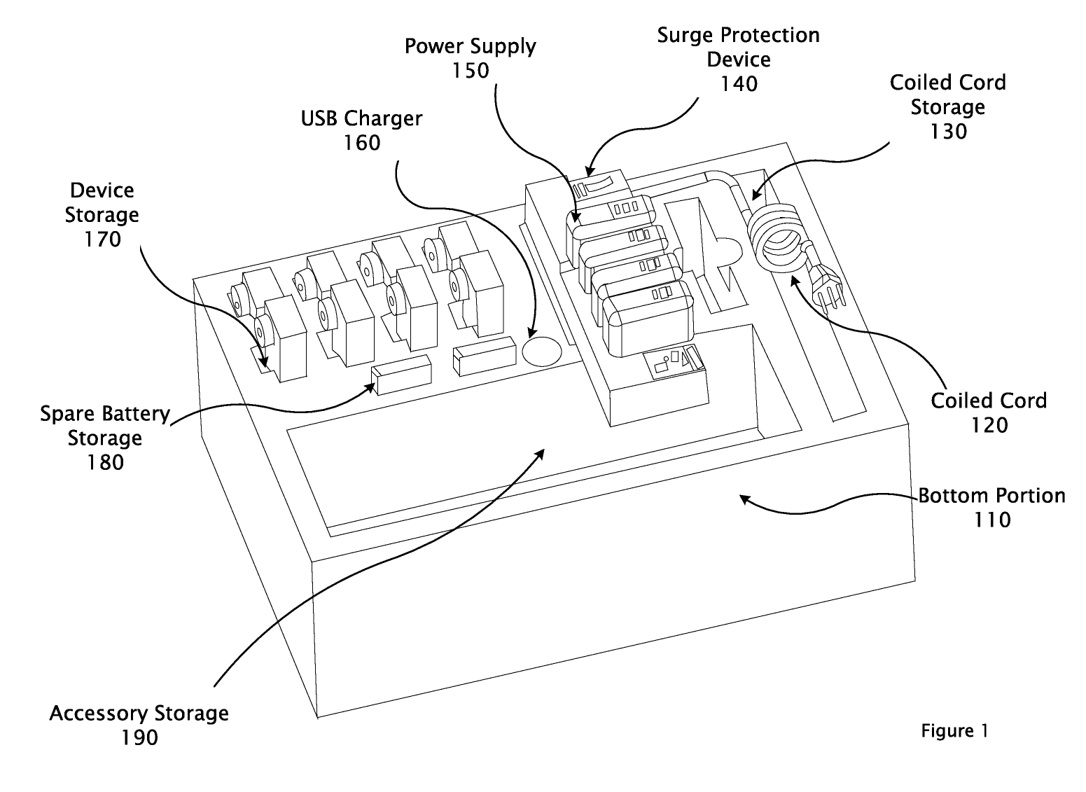

FIG. 1 illustrates a perspective view of a Device Storage Case and Charger, according to one embodiment. In this example, Bottom Portion 110 may comprise a case with compartments configured to hold multiple devices and accessories. Devices may include still cameras, video cameras such as point-of-view (POV) cameras, smartphones, tablets, laptop computers, smartwatches, smart eyewear, audio players, and video game consoles, for example. Accessories may include batteries, chargers, power cords, cables, adapters, lenses, flashes, remotes, data storage devices, memory cards, headphones, straps, housings, and tools, for example. Device Storage Case and Charger may also include individual pockets to carry extra power storage devices or any other items.

In one embodiment, Bottom Portion 100 may receive and hold at least one insert, such as a foam insert, which may have compartments configured to hold multiple devices and accessories, for example. The insert may have a finished surface that is textured and impermeable for easy cleaning.

Device Storage Case and Charger may allow for multiple methods of charging, for example, it may include multiple charging inputs. In one embodiment, it may include a 120 VAC (volts alternating current) extendable Coiled Cord 120, which may be stored in Coiled Storage 130. Coiled Cord 120 may attach to a built-in Surge Protection Device 140, which may be UL-listed, meaning it may have UL (Underwriters Laboratories) certification. Surge Protection Device 140 may include LED indicators showing AC (alternating current) present, line fault, and surge protection present. Surge Protection Device 140 may be protected via an internal resettable circuit breaker. Coiled Cord 120 may include a plug, for example, a US National Electrical Manufacturers Association (NEMA) 5-15P plug, which may have an optional clear body and LED “power on” indicator. Coiled Cord 120 may be mounted inside the case so that when energized, the case cannot be closed, eliminating the possibility of contained heat buildup, for example.

Device Storage Case and Charger may also include Power Supply 150 which may recharge devices using Universal Serial Bus (USB) cables, for example. It may also include USB Charger 160, which may also function as a cigarette lighter, for example. Device Storage Case and Charger may include standard AC adapters and USB cables, or a user may provide them separately. USB power cords with right angle or up/down strain relief connections may be connected via the AC adapter to stored devices, such as camera bodies, for example, or to extra batteries for charging. USB cables may also be routed within compartments, such as foam compartments, for protection. A power plug, such as a 12 VDC (voltage direct current) plug, may also be provided or may be supplied by a user as an additional charging source. Components such as Power Supply 150, USB Charger 160, Surge Protection Device 140, and Coiled Cord Storage 130 may be located in various positions in various embodiments, allowing for various advantages, for example, using minimal space inside the case, or minimizing cable runs. One skilled in the art will recognize that other benefits may be provided by various positioning of such components. One having skill in the art will recognize that Power Supply 150 may provide various charging connectors, and may be configured to provide various voltage or current requirements.

Among other features and configurations, Device Storage Case and Charger may also include Device Storage 170, which may receive and hold multiple devices, for example, point-of-view (POV) cameras such as GoPro® video cameras, or any other devices. It may also contain Spare Battery Storage 180 for safekeeping of additional batteries and Accessory Storage 190 to secure any additional items. Device Storage 170 and Accessory Storage 190 may be made of single or multiple density foam, and may be provided with cutout sections custom-fitted to selected devices, may be configured to allow users to cut out desired sections, or may have removable foam shapes to allow shaping of sections without cutting. In another embodiment, a plastic insert may be used to hold devices and accessories.

Device Storage Case and Charger may include features such as water-tight enclosure and fire resistance, for example, to protect its contents. It may also meet multiple industry standards such as carry-on requirements for airline travel, for example. It may include fastening means such as locking latches and corner eyelets for locking devices, as well as flush-mounted hinges for protection.

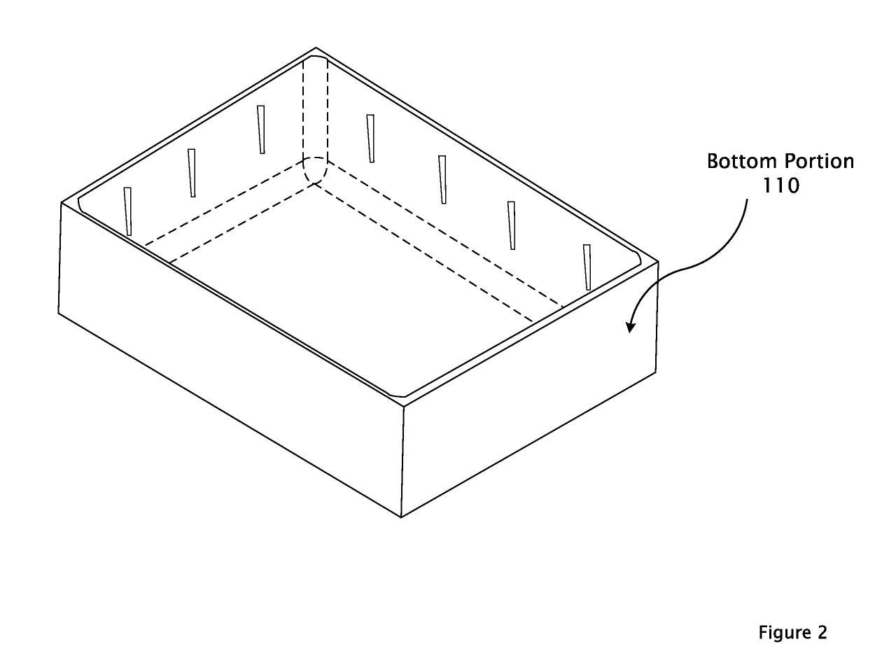

FIG. 2 illustrates a perspective view of a bottom portion of a Device Storage Case and Charger, according to one embodiment. Bottom Portion 200 may comprise a case configured to hold an insert having compartments to hold multiple devices and accessories, for example.

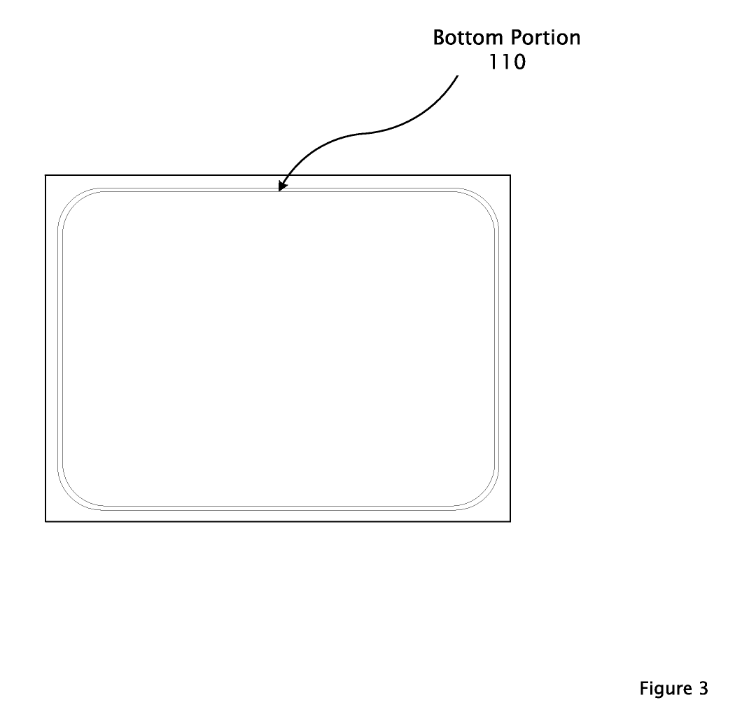

FIG. 3 illustrates a bottom view of a Device Storage Case and Charger, according to one embodiment. Bottom Portion 110 may be made with different shapes, colors, or sizes, and may be made of any material suitable for protecting the contents of Device Storage Case and Charger.

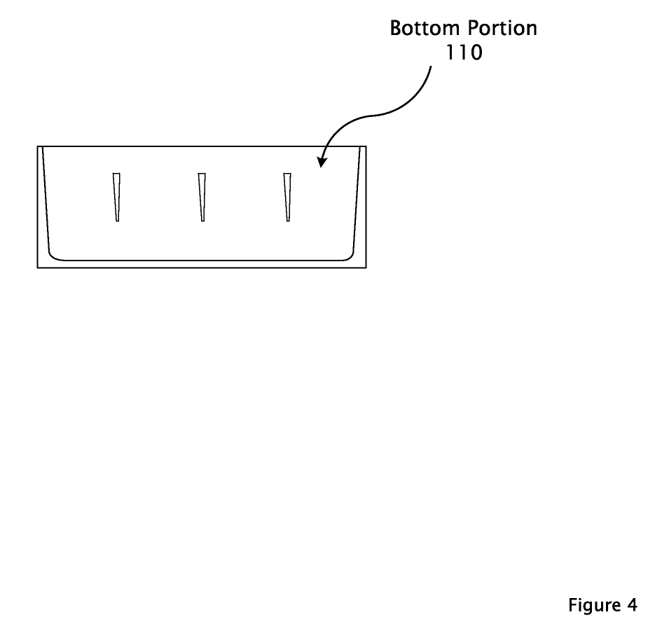

FIG. 4 illustrates a side view of a Bottom Portion 110 of a Device Storage Case and Charger, according to one embodiment.

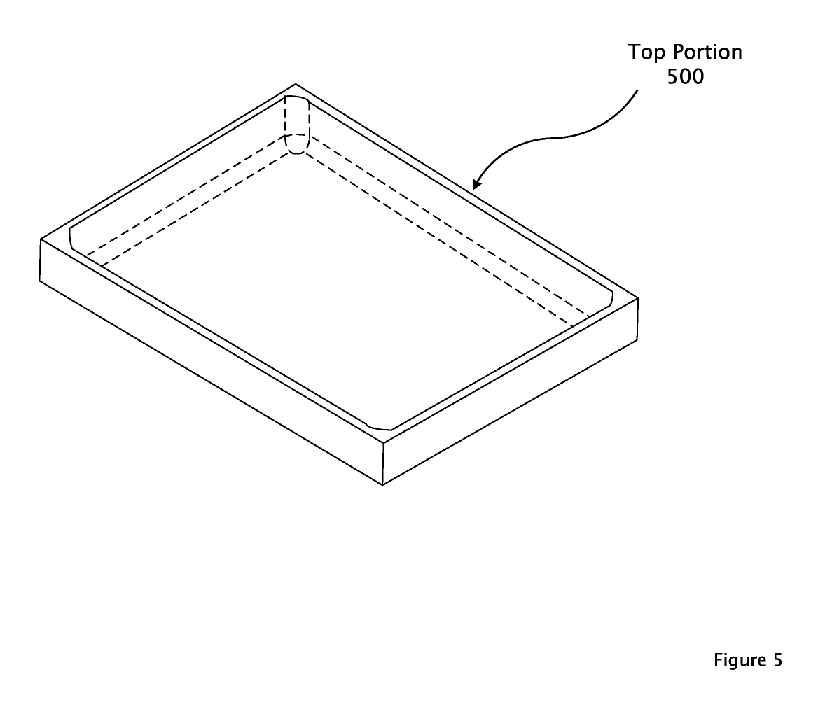

FIG. 5 illustrates a perspective view of Top Portion 500 of a Device Storage Case and Charger, according to one embodiment. Top Portion 500 may serve as a lid for Device Storage Case and Charger. It may include compartments or recesses to contain items such as accessories, documents, or devices such as electronic tablets or laptop computers, for example. Top Portion 500 may be configured hold at least one photovoltaic (PV) solar power source to provide power to devices, such as 12 VDC power. The compartments or recesses in Top Portion 500 may have fastening means such as hook-and-loop fastener straps or flexible fabric straps, for example, to secure items.

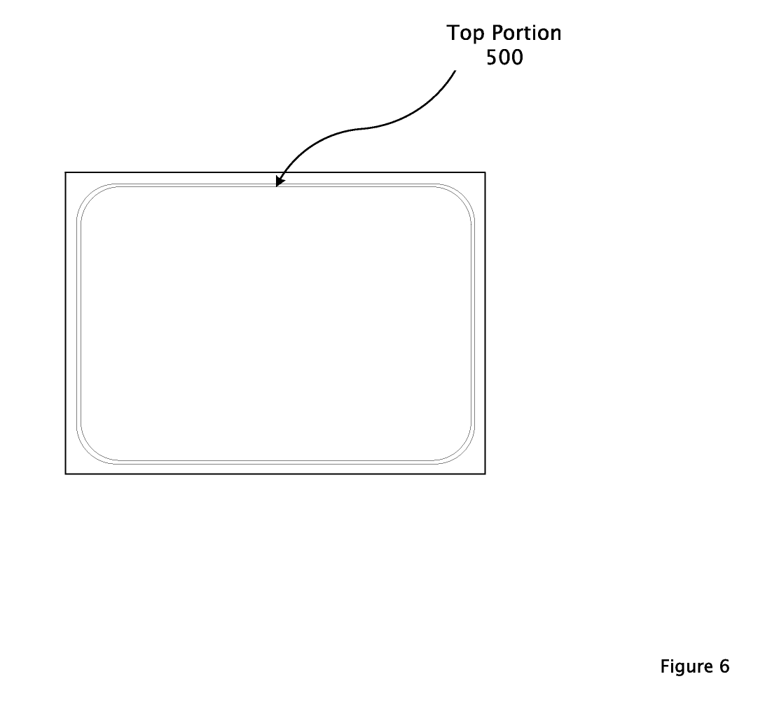

FIG. 6 illustrates a top view of Top Portion 500 of a Device Storage Case and Charger, according to one embodiment.

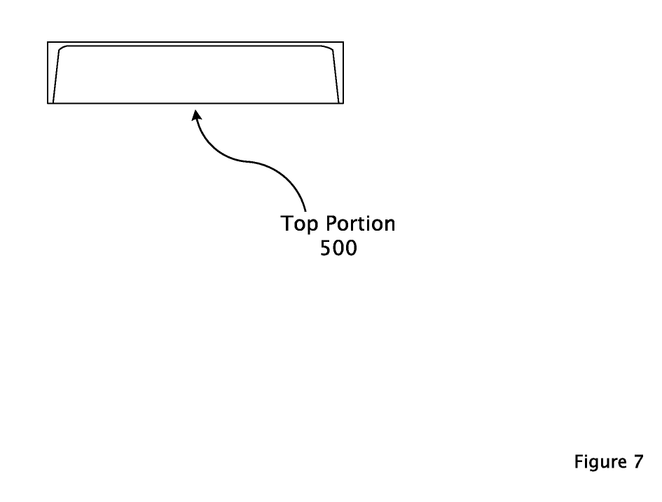

FIG. 7 illustrates a side view of Top Portion 500 of a Device Storage Case and Charger, according to one embodiment.

One having skill in the art will recognize that Device Storage Case and Charger may be made in various colors, sizes, and shapes, and may be made of various materials.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples, and data provide a complete description of the manufacture and use of the invention. Since many embodiments of the invention can be made without departing from the spirit and scope of the invention, the invention resides in the claims hereinafter appended.

1. A device storage case and charger comprising:
a bottom portion, the bottom portion having a plurality of storage compartments;
a top portion, the top portion having at least one storage compartment;
a surge-protected power supply;
a coiled power cord electrically coupled to the power supply; and
a charging plug electrically coupled to the power supply.

2. The bottom portion of claim 1 wherein the plurality of storage compartments comprises multiple density foam.

3. The bottom portion of claim 1 wherein the plurality of storage compartments include fasteners from the list containing latches, eyelets, hinges, fasteners, and straps.

5. The device storage case and charger of claim 1 wherein at least one of the storage compartments is configured to hold a spare battery.

6. The device storage case and charger of claim 1 wherein at least one of the storage compartments is configured to hold a point-of-view camera.

7. The top portion of claim 1 wherein at least one storage compartment is configured to hold a solar power source electrically coupled to the power supply.

8. The device storage case and charger of claim 1 wherein the charging plug is selected from the list containing a USB plug, a micro-USB plug, an HDMI plug, a BNC plug, a coaxial cable plug, and an RCA plug.

9. The device storage case and charger of claim 1 wherein the top portion and bottom portion couple to provide a waterproof case.
